(19) United States
(12) Patent Application Publication
(10) Pub. No.: US 2012/0060881 A1
(43) Pub. Date: Mar. 15, 2012

(54) COLLAPSIBLE PORTABLE CHANGING BOOTH WITH HEIGHT ADJUSTMENT ASSEMBLY

(76) Inventor: Thanh T. Ly-Cho, Las Vegas, NV (US)

(21) Appl. No.: 13/229,613

(22) Filed: Sep. 9, 2011

Related U.S. Application Data
(60) Provisional application No. 61/403,392, filed on Sep. 15, 2010.

(51) Int. Cl. E04H 15/44; B23P 11/00

(52) U.S. Cl. 135/121; 29/428

(57) ABSTRACT

A portable and collapsible changing booth is disclosed herein. The changing booth provides privacy for users that wish to change clothes. The changing booth may be lightweight and portable. In addition, the changing booth is collapsible so as to be easily transported and stored. The changing booth may comprise a tubular cover resiliently supported by a spring. A user may position him or herself within the tubular cover to change. One or more adjustable drawstrings allow the height of the tubular cover and spring to be set at various levels from fully compressed to fully expanded. This allows the changing booth to accept users of various sizes.

### CROSS-REFERENCE TO RELATED APPLICATION

This application claims priority to U.S. Provisional Application No. 61/403,392, titled Collapsible Portable Changing Booth with Adjustable Height, filed Sep. 15, 2010.

### BACKGROUND OF THE INVENTION

1. Field of the Invention

The invention relates to privacy stations and in particular to a collapsible portable changing booth with height adjustment assembly.

2. Related Art

In leisure time and other activities it is often desirable or necessary to change ones clothing prior to or after the activity. For example, beachgoers or swimmers may arrive at the pool or the ocean in their regular clothing and then change into swimwear. Similarly, after swimming or enjoying a day at the beach, a swimmer or beachgoer may desire to get out of their swimwear, which may be wet, for the journey home.

In some places, facilities may be provided for the purpose of changing ones clothes. For example, a public bathroom provides privacy for changing. However, many times, especially with outdoor activities, there may be no such facilities, or such facilities may be distant. In addition, such facilities may be unsanitary and potentially unsafe. Though the desire for privacy is well spread, people have been known to resort to change in their cars or awkwardly change while covering up with a towel as a result.

From the discussion that follows, it will become apparent that the present invention addresses the deficiencies associated with the prior art while providing numerous additional advantages and benefits not contemplated or possible with prior art constructions.

### SUMMARY OF THE INVENTION

A collapsible portable changing booth with an adjustable height is disclosed herein. The changing booth may have various configurations. For example, in one exemplary embodiment, a collapsible changing booth comprises a coil spring (biased to expand) having a top end and a bottom end and a diameter configured to accept a user therein, and a tubular cover comprising a non-transparent fabric attached at one or more points to the coil spring. The cover may be flexible to expand and contract with the coil spring;

One or more channels may extend along the length of the tubular cover so that one or more drawstrings anchored at the bottom end may extend into the channels.

One or more locking mechanisms may be provided to stop the expansion of the coil spring by engaging the top end of the coil spring. The locking mechanisms may be releasably secured to the drawstrings so as to be movable along the length of the drawstrings. This allows the locking mechanisms to engage the coil spring at various heights and thus allows the height of the changing booth to be set as desired. A bottom having one or more layers of material may be used to enclose the bottom end of the coil spring and support the user thereon. The bottom may comprise a rigid material. Alternatively or in addition, the layers of the bottom may be padding or padded.

The locking mechanisms may have various configurations as well. For example, the locking mechanisms may comprise an outer enclosure having one or more openings to accept the drawstrings, an inner block at least partially within and movable within the outer enclosure, and one or more biasing mechanisms configured to compress the drawstrings between the inner block and the outer enclosure to secure the drawstrings. The inner block will typically be movable by the user to release the drawstrings so that the locking mechanisms can be positioned at a new elevation. It is noted that the inner block may be configured to move upward to release the drawstrings, and downward to secure the drawstrings.

The cover may include one or more transparent sections at a top end of the cover to allow the user to view of the user's surroundings. The coil spring may be embedded between at least two layers of the cover at the points of attachment. In addition, a lid may be provided to enclose the top end of the coil spring.

In another exemplary embodiment, a collapsible changing booth may comprise a non-transparent tubular covering having a top end and a bottom end and a diameter configured to accept a user therein, and a spring having substantially the same diameter as the tubular covering. The spring will typically be attached to the tubular covering at one or more points such that the tubular covering and the spring expand and contract together.

One or more elongated members may extend from the bottom end and one or more locking mechanisms may be configured to secure to a plurality of points along the length of the elongated members. The locking mechanisms can then engage the spring to prevent the spring from expanding beyond a particular point, thus setting the height of the changing booth.

It is noted that the elongated members may be cords, and that the locking mechanisms may be cord cinchers. One or more straps may be provided at the bottom end of the tubular covering to hold the spring in a collapsed state.

Various methods of providing privacy during changing are disclosed herein as well. For example, in one exemplary embodiment a method of providing a collapsible changing booth may comprise providing a non-transparent tubular covering supported by a spring having a diameter configured to accept a user therein and configured to bias toward an expanded state, attaching one or more elongated members at a bottom end of the tubular covering, and providing one or more releasable locking mechanisms configured to engage the spring to prevent the spring from expanding beyond a particular height.

A user may then be accepted within the tubular covering and the diameter of the spring. For example, a user may step into the changing booth such that he or she is positioned within the tubular covering and the spring. The user may then change in the privacy of the changing booth.

The locking mechanisms may be secured to the elongated members at the particular height to set the height of the collapsible changing booth. The locking mechanisms may also be released from the one or elongated members and re-securing the locking members at another particular height to set a new height for the collapsible changing booth.

A lid may be attached to a top end of the tubular covering to enclose the top end. In addition, as part of the method, the tubular covering may be attached to the spring at one or more points so that the tubular covering and the spring expand and contract together.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a front perspective view of an exemplary collapsible portable changing booth in an expanded state;

FIG. 2 is a front perspective view of an exemplary collapsible portable changing booth in a partially collapsed state;

FIG. 3 is a front perspective view of an exemplary collapsible portable changing booth in a fully collapsed state;

FIG. 4A is a cross-sectional view of an exemplary locking mechanism in a locked state;

FIG. 4B is a cross-sectional view of an exemplary locking mechanism in an unlocked state;

FIG. 4C is a cross-sectional view of an exemplary locking mechanism;

FIG. 5 is a perspective view of an exemplary collapsible portable changing booth in a first state of use;

FIG. 6 is a perspective view of an exemplary collapsible portable changing booth in a second state of use; and

FIG. 7 is a perspective view of an exemplary collapsible portable changing booth in a third state of use.

### DETAILED DESCRIPTION OF THE PREFERRED EMBODIMENTS

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

A collapsible portable changing booth with an adjustable height is disclosed herein. In general, the changing booth allows its user the convenience of changing clothes in almost any setting while providing a private and sanitary environment. Because the booth is collapsible, it is convenient for travel, allowing the user to bring it to a variety of places such as the beach, a campsite, or a soccer game. In addition to being able to carry the booth almost anywhere, the user can also adjust the booth's height to suit his or her needs or comfort level, while inside or outside of the booth.

The changing booth may have various configurations. As an example, in one embodiment, the changing booth may comprise a spring coil encased in lightweight, flexible, non-transparent textile forming a cylindrical booth. Drawstring cords may run along the sides of the cylindrical booth through vertical sheaths of similar lightweight and flexible textile. A circular bottom may be attached to one end of the cylinder, and a circular top which closes the top side of the cylinder (and may be removable) may be at another end of the cylinder. One or more buckles may be attached to sides of bottom of the booth to help keep the portable changing booth in a flat or compacted state for easier storage. Carrying straps may be included as well. The user can adjust the height of the booth by using the drawstrings and lock the booth at the adjusted height with a drawstring fastener such as a ring pull cord cincher or self-locking cord lock.

It can be seen that the changing booth is therefore highly versatile in that it can be used to carry items, less awkward to use and handle, simple to use, requiring little or no assembly by the user, height adjustable to suit each unique user, and easily compacted for storage and transport. In addition, it can be seen that the changing booth is advantageous in that it provides a private area or location virtually anywhere at which a user may change his or her clothes.

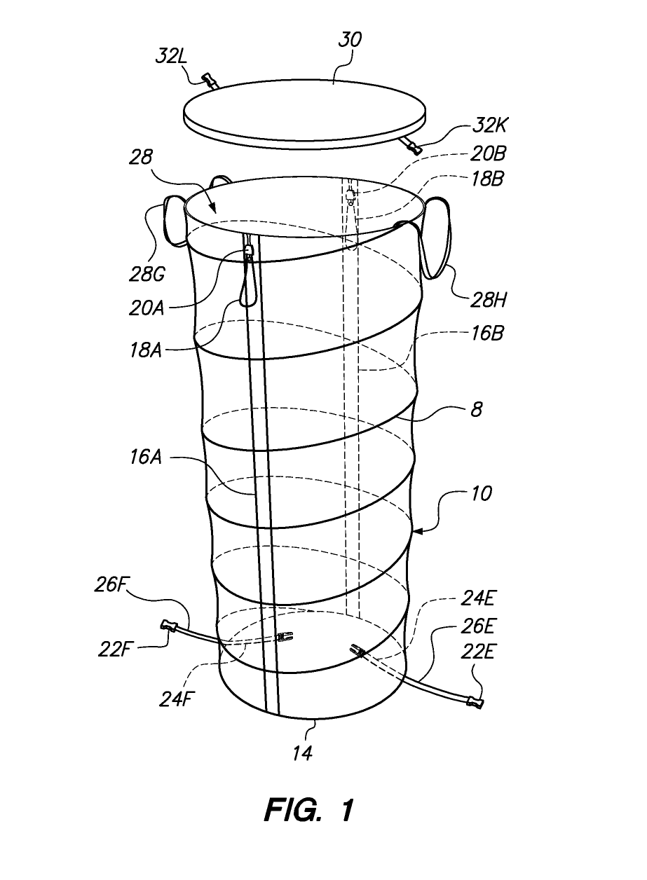

The changing booth will now be described with regard to FIGS. 1-3. As can be seen, FIGS. 1-3 provide perspective views of an exemplary changing booth in various states. As shown, the changing booth is transitioning between a expanded state and a collapsed state. As will be described further below, the changing booth may have one or more expanded states in which a user may change or otherwise use the changing booth, and one or more collapsed states in which a user may store or transport the changing booth.

Referring now to FIG. 1, in one or more embodiments, the changing booth may comprise coil spring 8 to allow it to automatically expand while remaining collapsible. As can be seen, the coil spring 8 may form a structure or frame of the changing booth that supports other elements of the changing booth, such as its sheath or cover 10. In this manner, the changing booth can be self-supporting.

The coil spring 8 may be configured to bias toward an expanded state, such as shown in FIG. 1. In this manner, the changing booth can automatically expand during use. The coil spring 8 may be constructed in various ways. For example, various materials may be used in the formation of the coil spring 8. In one or more embodiments, the coil spring 8 may be formed from one or more metals or alloys. It is contemplated that various resilient or semi-rigid materials could be used as well.

A cover 10 may be provided to conceal a user from view, thus providing the user privacy. The cover 10 may be a flexible non-transparent material, such as a fabric or textile including natural or synthetic materials/fibers (e.g., cotton, nylon, polypropolene). This allows the cover 10 to collapse and expand as the coil spring 8 does. In one or more embodiments, the cover 10 may be tubular in shape to allow it to accommodate a user therein. For example, as shown in FIG. 1, the cover 10 has a cylindrical tubular shape. An opening 28 may be at the top (and/or bottom) end of the cover 10. In general, the opening 28 at the top end will be configured to allow users to enter the cover 10, as will be described further below.

The cover 10 may wrap around the changing booth to block a user from view. Typically, the cover 10 will wrap completely around the changing booth, such as shown in FIG. 1. In this manner a user is surrounded by the cover and his or her privacy is ensured. It is contemplated that in some embodiments, the cover 10 may have one or more transparent sections, such as at its top so as to allow the user a view of the outside. The transparent sections may be positioned such that they are at the user's eye level, thus preserving coverage of the majority of the user's body.

The cover 10 may attach to a coil spring 8 at one or more points. For example, the cover 10 may attach only to the top of the coil spring 8, so that as the top of the coil spring moves, so does the cover 10. In this manner, the cover 10 may be raised or lowered as the coil spring 8 expands or contracts, respectively. The cover 10 could also attach to one or more sections or loops of the coil spring 8, to the bottom of the spring, or both. This provides increased support for the cover 10 as it is anchored at intermediate points along the length of the coil spring 8.

As shown in FIGS. 1-3, the cover 10 and coil spring 8 may be attached to one another by integrating or embedding the coil spring into the cover. For example, the coil spring 8 may be sewn into the cover 10. In another embodiment, the cover 10 may have a spiraling channel along its length to accept the coil spring 8.

It is contemplated that the cover 10 may be removably attached to the coil spring 8 in some embodiments. This allows the cover 10 to be removed, such as for cleaning, replacement, or repair. Likewise, the coil spring 8 would be removable from the cover for maintenance or replacement. In one or more removable embodiments, one or more fasteners, such as clips, clamps, screws, hook and loop fasteners, zippers, magnets, or the like could be used to removably attach the cover 10 to the coil spring 8. In an embodiment having spiraling channel which accepts the coil spring 8 (as described above), the coil spring 8 could be removed by rotating it out of the spiraling channel.

It is noted that though shown in a cylindrical shape, the coil spring 8 and/or cover 10 may have various shapes. For example, the cross-sectional shape of the coil spring 8 and/or cover 10 may be square, rectangular, oval, polygonal, include one or more curves, or various combinations thereof. Embodiments of different shapes are beneficial in that they allow the changing booth to fit in to various areas for storage and/or use.

In one or more embodiments, the changing booth may have a bottom 14, which encloses (partially or fully), the bottom end of the changing booth. This is beneficial in that it gives a user a surface upon which to stand when changing. The bottom 14 thus prevents the user or his or her clothing from contacting the ground. In addition, anything the user inadvertently drops will be collected at the bottom 14 of the changing booth. The bottom 14 may be waterproof in some embodiments, to prevent moisture from contacting the user. This is beneficial when the user is changing to clean clothes, or his or her ordinary clothes.

The bottom 14 may be rigid in some embodiments. This provides a structure upon which users may be supported when using the booth. For example, the bottom 14 may be constructed from wood, metal, plastic, or other rigid material. In this manner, any rough or uneven terrain may be smoothed out by the bottom 14. The user thus need not worry about injury even when barefoot.

In other embodiments, the bottom 14 may be flexible or semi-rigid. For example, the bottom 14 may be made from rubber, flexible plastic, fabric, or the like.

This allows the bottom 14 to conform at least somewhat to the ground or other surface on which it is placed. In addition, the bottom 14, though not rigid, may provide some padding to cushion the user from ground or other surface contact. It is contemplated that the bottom 14, rigid or not, may include a layer of padding to accomplish the same. Such padding may be made of rubber, foam, sponge or other padding material.

The bottom 14 may attached to a bottom end of the coil spring 8. In this manner, the coil spring 8 may expand upward away from the bottom 14 when in use, and contract downward toward the bottom when collapsed. In one or more embodiments, the bottom 14 may be removably attached, such as for cleaning, maintenance, or replacement purposes. One or more removable fasteners, such as the clips, clamps, screws, zippers, magnets, and hook and loop fasteners described above may be used to attach the bottom 14. In some embodiments, the bottom 14 may be integrated into the cover 10 and/or coil spring 8. For example, the cover 10 may have a bottom portion which enclose its tubular shape at a bottom end.

It is contemplated that the changing booth may also or alternatively have a top or lid 30 at its top end. As can be seen, the lid 30 may be used to enclose, partially or fully, the opening 28 at the top of the changing booth. This is beneficial in areas where people are at various elevations. For example, a user may utilize the lid 30 when using the changing booth near a highrise building or the like. That way, others cannot peer into the changing booth from above. In addition, the lid 30 may be used in inclement weather, such as during rain or snow, to protect the user from these elements. This would be advantageous when a user is changing when camping or hiking for example.

The lid 30 may be separable from the changing booth so that it need not be transported with the changing booth if not desired. In such embodiments, the lid 30 may be completely removed to open the changing booth, and replaced at the opening 28 to enclose the changing booth. One or more fasteners 32K,32L, such as clips, clamps, magnets, hook and loop fasteners, zippers, and the like may be used to secure the lid 30 in a closed position. For instance, as shown the fasteners 32K,32L comprise snaps at the ends of a flexible member which may be aligned and connected to fasten the lid 30 to the changing booth.

It is contemplated that the lid 30 may be attached to the changing booth in some embodiments. For example, the lid 30 may be hinged or pivotably mounted to the changing booth in some embodiments. The lid 30 may be a rigid or flexible structure. It is contemplated that the lid 30 may be waterproof. In addition, the lid 30 may be a non-transparent material.

Another advantage of the changing booth is that it is height adjustable in one or more embodiments. This can be seen in FIGS. 1-3, which illustrate the changing booth at various heights. Height adjustment allows the changing booth to easily accommodate users of various sizes. For example, the changing booth may be allowed to expand further to accommodate taller users while not as much for shorter users. In addition, the height adjustment allows users to set the height of the changing booth such that they remain able to see around them. In other words, the changing booth may be set to eye, head, shoulder or similar level to allow the user a view around themselves. The user may feel less claustrophobic, and may avoid danger (after seeing it) in this way.

In addition, the height of the changing booth may be set to more easily accept a user. For example, the changing booth may be lowered to allow a user to easily step into the changing booth and then subsequently raised to allow the user to change in private. Once done, the user may lower the changing booth again to step out of the booth. Another or the same user may then use the changing booth by stepping into it again. Since the height of the changing booth may be set the user need not worry about holding the changing booth's coil spring down in order to enter or exit the changing booth.

Also, the height adjustment capability allows users to set the height of the changing booth as they desire. For example, a person changing only their bottoms may wish to set the changing booth at torso or waist height. This may permit their arms to move more freely thus making changing easier. A person changing their top may wish to set the changing booth's height higher to conceal the person's upper body as he or she is changing. In addition, some users may be self-conscious of some body parts while not self-conscious of others. The adjustable height allows the user to specify the amount of concealment so that the user need not be fully enclosed in all situations. This is beneficial in that, as stated, it can allow the user a view of his or her surroundings, lets the user feel less claustrophobic, and can make changing easier if/when the user's arms need not be concealed.

A height adjustment assembly may be provided in one or more embodiments to allow the height of the changing booth to be set. In general, the height adjustment assembly will be configured to hold or secure the changing booth at a particular height. For example, in one embodiment, the height adjustment assembly may hold or secure the coil spring 8 at a particular height, thus causing the overall changing booth to have that particular height. In one or more embodiments, this may occur by preventing the coil spring 8 from expanding beyond a particular point.

The height adjustment assembly may have various configurations. Referring to FIG. 1 for example, the height adjustment assembly may comprise one or more drawstrings 18A,18B and locking mechanisms 20A,20B. The drawstrings 18A,18B may be attached to the bottom 14 or at a bottom end of the changing booth and extend upward therefrom. This anchors one end of the drawstrings 18A,18B so that the remainder of the drawstrings 18A,18B may be used to control the height of the changing booth, as will now be described.

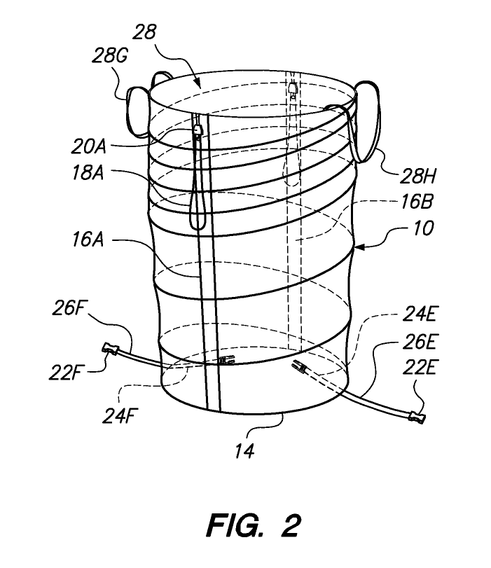

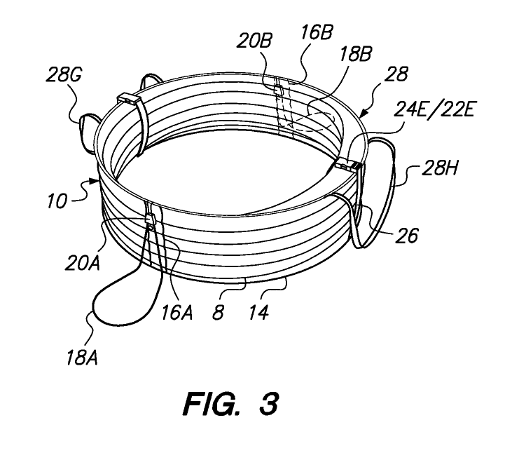

As discussed above, the coil spring 8 may be configured such that it biases upward or to an expanded state, such as that shown in FIG. 1. Without any intervention the coil spring 8 may thus expand to a fully extended state, such as shown in FIG. 1. The height adjustment assembly may prevent the fully extended state by physically restraining the coil spring 8 at a particular height. This sets the height of the changing booth, such as shown in FIG. 2. The height of the changing booth can be set so low that the changing booth is effectively collapsed making it easily transportable and storable, such as shown in the fully collapsed state of FIG. 3.

Once collapsed, it is noted that the changing booth may be secured in this position, such as for storage or transport. For instance, in one or more embodiments, one or more straps 26E,26F may be provided to hold the changing booth in a collapsed state. The straps 26E,26F may have couplers or buckles 22E,22F at their ends so that their ends may couple together. The straps 26E,26F may extend from opposite sizes of the bottom 14 of the changing booth, as can be seen in FIG. 1. Once collapsed the ends of the straps 26E,26F may be connected using the buckles 22E,22F (or other fasteners, or by tying) to form a loop around a portion of the coil spring 8, to hold the coil spring in a collapsed state, as can be seen in FIG. 3. It is noted that other fasteners may be used as well, such as those mentioned above. It is also noted that the changing booth may include one or more handles 28G, 28H to allow the changing booth to be easily moved or carried, such as when in the collapsed state.

In one or more embodiments, the drawstrings 18A,18B provide a structure to which the locking mechanisms 20A,20B may be secured. The position at which the locking mechanisms 20A,20B are secured sets the height of the changing booth. This is because the locking mechanisms 20A,20B function as a physical stop to the expansion of the coil spring 8. This can be seen in FIG. 2 and FIG. 3 where the expansion of the coil spring 8 has been stopped at a particular height by the locking mechanisms 20A,20B.

As stated above, one end of the drawstrings 18A,18B may be anchored to the bottom 14 or at a bottom end of the changing booth. Since the drawstrings 18A,18B are anchored in this way, once the coil spring 8 comes into contact with the locking mechanisms 20A,20B its expansion is stopped thus setting the height of the changing booth.

The locking mechanism 20A,20B may move along the length of the drawstrings 18A,18B, and may be secured at any point thereon. To lower the height of the changing booth for example, the locking mechanisms 20A,20B may be moved to and then secured at a low point of the drawstrings 18A,18B, such as shown in FIG. 3. To raise the height of the changing booth, the locking mechanisms 20A,20B may be moved to and secured at a higher location. This allows the coil spring 8 to expand more, thus raising the height of the changing booth, such as shown in FIG. 2.

As can be seen, the length of the drawstrings 18A,18B may set the maximum height of the changing booth in some embodiments, since the changing booth cannot expand beyond the position of its locking mechanisms 20A,20B. Thus, if the drawstrings 18A,18B are shorter than the fully expanded length of the coil spring 8, the drawstrings will define the maximum height of the changing booth.

As can be seen from FIGS. 1-3, the drawstrings 18A,18B can be elongated structures, such as elongated members. Though shown as a loop in FIGS. 1-3, it is contemplated that the drawstrings 18A,18B may be non-looped or may be a single strand. The loop configuration is beneficial in that it prevents a locking mechanism 20A,20B from sliding off of a drawstring 18A,18B at the top end of the drawstring.

Typically, a drawstring 18A,18B will be flexible to allow it to bend and compress as well as expand along with the changing booth. For example, a drawstring 18A,18B may be a cord or rope like item made from natural or synthetic materials (e.g., nylon cord, nylon webbing, elastic/bungee cords, rope).

It is noted that fewer or additional drawstrings 18A,18B than illustrated may be used to provide height adjustability. In addition, in some embodiments, the drawstrings 18A,18B may be replaced with rigid or semi-rigid structures, such as elongated members for example. In such embodiments, the locking mechanisms 20A,20B may still be moved and secured along the length of the elongated members to adjust the height of the changing booth. The rigidity of the elongated members may be used to provide additional structure or support to the changing booth, especially if rigidly mounted to the bottom 14. It is contemplated that rigid elongated members may be made removable to allow the changing station to be more easily stored when compressed.

In one or more embodiments, the drawstrings 18A,18B may be encased in or extend through one or more sheaths 16A,16B. As shown for example, the sheaths 16A,16B form a channel through which the drawstrings 18A,18B may extend. This supports the drawstrings 18A,18B by holding the drawstrings adjacent the cover 10. The sheaths 16A,16B may be flexible in one or more embodiments to allow them to expand and contract with the cover 10 and coil spring 8. Though shown as extending along the length of the cover 10, it is noted that the sheaths 16A,16B may only extend a partial distance of the cover 10 in some embodiments.

The locking mechanisms 20A,20B may have various configurations as well. In general, the locking mechanisms 20A,20B engage a portion of a drawstring 18A,18B to secure itself thereto at that location. In one or more embodiments, the locking mechanisms 20A,20B may squeeze a drawstring 18A,18B to secure to the drawstring. Various cord locks, cord cinchers, cord fasteners, or the like may be used to form a locking mechanism 20A,20B. Cord locks or cord cinchers with self-locking capabilities may be used as well.

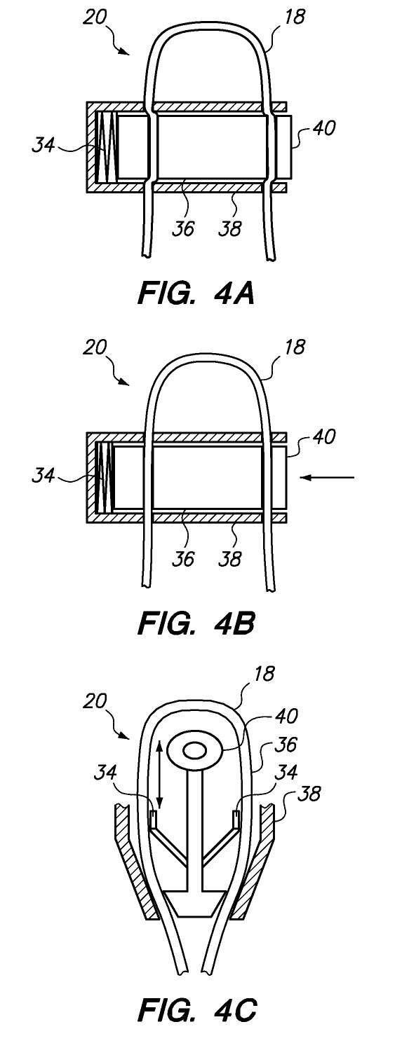

FIGS. 4A-4B illustrates an exemplary locking mechanism 20 As can be seen, the locking mechanism 20 may have an inner block 40 which is movable relative to an outer enclosure 32. Both the inner block 36 an outer enclosure 38 may have one or more openings to allow a drawstring 18 to pass therethrough. The inner block 36 may be biased outward or inward by a biasing mechanism, such as the spring 34 shown in FIGS. 4A and 4B. As illustrated the spring 34 biases outward.

In operation, the locking mechanism 20 may secure itself to a particular point of the drawstring 18 by its inner block 36 shifting position such that the openings of the inner block and outer enclosure 38 no longer align. This in effect clamps the locking mechanism 20 to the drawstring 18, as can be seen in FIG. 4A. The locking mechanism 20 is thus held at this particular location of the drawstring 18 thereby serving as a stop to the changing booth's coil spring at this particular location.

The locking mechanism 20 may be released by releasing the clamping pressure on the drawstring 18. For example, the inner block 36 may be moved to align its openings with that of the outer enclosure 38. In this manner, the locking mechanism 20 may move freely along the length of the drawstring 18. As shown in FIG. 4B, this alignment may occur by pressing the inner block 36 at point 40 to move it relative to the outer enclosure 38. Once the locking mechanism 20 is at a desired position (i.e., height) along the length of a drawstring 18, it may be secured once again. In the embodiment of FIGS. 4A-4B, this may occur by releasing the inner block 36 allowing the spring 34 to misalign the openings and thus secure the locking mechanism 20 to the drawstring 18 once again.

FIG. 4C illustrates another exemplary locking mechanism 20 that may be used with the changing booth. As can be seen, this locking mechanism 20 includes a outer enclosure 38 and an internal block 36 which together apply pressure to the drawstring 18 to secure the locking mechanism 20 to the drawstring. In this embodiment, moving the internal block 36 toward the tapered end of the outer enclosure 38 pinches the drawstring 18, thus securing the locking mechanism 20 to the drawstring. The locking mechanism 20 may be released by pulling the internal block 36 away from the tapered end of the outer enclosure 38, such as by grasping and pulling at point 40.

Multiple biasing devices 34 are shown in FIG. 4C to bias the internal block 36 toward the tapered end of the outer enclosure 38. This also applies the force to secure the locking mechanism 20 by pressing the internal block 36 against the drawstring 18 at the tapered end.

A locking mechanism 20 of the type shown in FIG. 4C will typically be installed tapered end down. In this manner, a user may pull upward on point 40 to release the locking mechanism 20. This is beneficial in that the user may simply continue that upward motion to move the locking mechanism 20 up the drawstring 18, thus setting the height of the changing booth in one motion. When the user releases the locking mechanism 20 at point 40, the locking mechanism may automatically secure itself once again. As can be seen, this allows the changing booth to go from a compressed state to an expanded state very quickly and easily.

Referring back to FIGS. 1-3, it is contemplated that locking mechanisms 20A,20B need not be at the top of the changing booth. For instance a drawstring 18A,18B may be anchored to the top end of the cover 10 or coil spring 8. In such case, the locking mechanisms 20A,20B may be at the bottom of the changing booth or elsewhere as long as the locking mechanisms 20A,20B can still prevent full expansion of the coil spring 8.

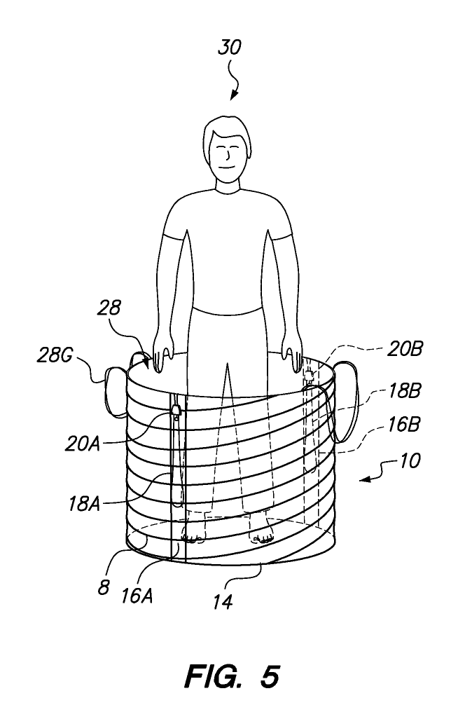

Operation of the changing booth will now be described with regard to FIGS. 5-7. The user may begin using the changing booth in a collapsed form, such as shown in FIG. 5. It is noted that the user may begin with the changing booth in a fully collapsed state, such as shown in FIG. 3.

The changing booth may be laid flat, allowing the compressed coil spring 8 and locking mechanisms 20A,20B to be oriented upward. The user may then step into the changing booth placing his or her feet on the bottom 14 of the changing booth. If secured in the collapsed stated, the user may release the coil spring, such as by uncoupling one or more straps or undoing one or more fasteners which secure the coil spring in the collapsed state.

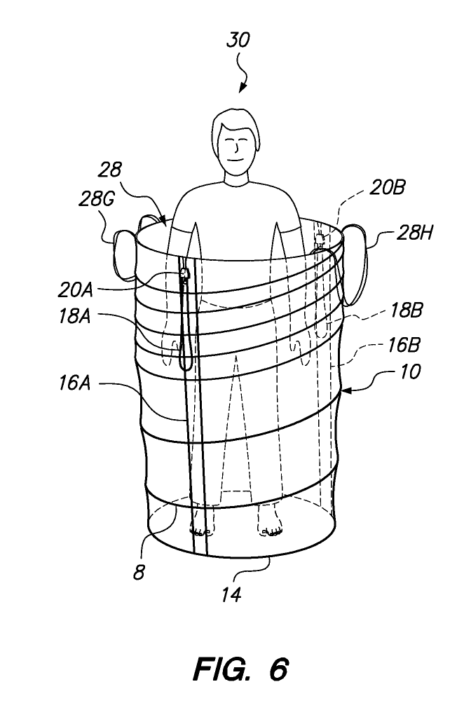

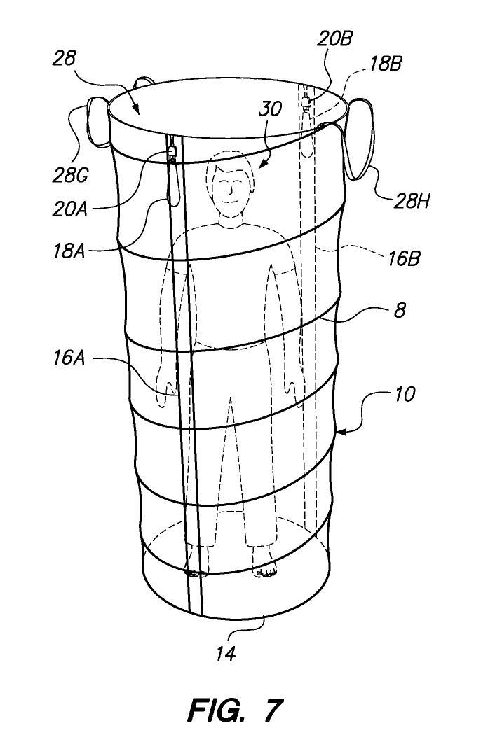

The user may then release the one or more locking mechanisms 20A,20B to allow the coil spring 8 and thus the changing booth to expand upward, such as shown in FIGS. 6-7. The locking mechanisms 20A,20B may be released as disclosed above or according to the type of locking mechanism used. For example, in the case where the locking mechanisms 20A,20B are ring pull cord cinchers/locks, the user may pull rings on the cord cinchers or cord locks located on sides of the changing booth, thereby releasing the locking mechanisms.

The locking mechanisms 20A,20B may be moved to a new position and secured there. This will define a new height for the changing booth. For example, moving the locking mechanisms 20A,20B from their position in FIG. 5 to their position in FIG. 6 or 7 defines an increased height, while moving from the positions of FIG. 6 or 7 to FIG. 5 defines a decreased height.

When the height is to be increased, moving the locking mechanisms 20A,20B releases tension in the coil spring 8 causing it to expand upward. As it becomes uncompressed, the height of the cover 10 (and the changing booth overall) is raised. The user may secure the changing booth at a desired height simply by securing the locking mechanisms 20A,20B. For example, the user may cease pulling on the cord cinchers to secure them to the drawstrings at a new location. As can be seen from FIGS. 5-7, the user may choose which height suits them for both getting into and changing in the changing booth. To illustrate, FIGS. 6-7 respectively show users who desire to have a view of the surrounding area, and to be completely concealed by the changing booth.

Once a desired height has been set, the user may change. As can be seen the diameter of the coil spring 8 and cover 10 may be such that adequate or ample space for various sized users is provided to move about during changing. For example, the diameter of the changing booth's coil spring 8 and cover 10 may be between 2 and 6 feet in some embodiments.

After the user has finished changing his or her clothes, the user may then recompress the booth by releasing the locking mechanisms 20A,20B and pushing them downward while holding onto the drawstrings 18A,18B. The changing booth may be collapsed in this manner without the need for twisting or folding the changing booth which may be cumbersome given that the changing booth includes a coil spring 8.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A collapsible changing booth comprising:
a coil spring having a top end and a bottom end and a diameter configured to accept a user therein, the coil spring biased to expand;
a tubular cover comprising a non-transparent fabric attached at one or more points to the coil spring, wherein the cover is flexible to expand and contract with the coil spring;
one or more channels extending along the length of the tubular cover;
one or more drawstrings anchored at the bottom end and extending into the one or more channels;
one or more locking mechanisms configured to stop the expansion of the coil spring by engaging the top end of the coil spring, the one or more locking mechanisms releasably secured to the one or more drawstrings so as to be movable along the length of the one or more drawstrings; and
a bottom having one or more layers of material, the bottom configured to enclose the bottom end of the coil spring and support the user thereon.

2. The collapsible changing booth of claim 1, wherein the one or more locking mechanisms comprise:
an outer enclosure having one or more openings to accept the one or more drawstrings;
an inner block at least partially within and movable within the outer enclosure;
one or more biasing mechanisms configured to compress the one or more drawstrings between the inner block and the outer enclosure to secure the one or more drawstrings; and
wherein the inner block is movable by the user to release the one or more drawstrings.

3. The collapsible changing booth of claim 2, wherein the inner block is configured to move upward to release the one or more drawstrings, and downward to secure the one or more drawstrings.

4. The collapsible changing booth of claim 1, wherein the cover includes one or more transparent sections at a top end of the cover to allow the user to view of the user's surroundings.

5. The collapsible changing booth of claim 1, wherein the coil spring is embedded between at least two layers of the cover at the one or more points of attachment.

6. The collapsible changing booth of claim 1 further comprising a lid configured to enclose the top end of the coil spring.

7. The collapsible changing booth of claim 1, wherein the bottom comprises a rigid material.

8. The collapsible changing booth of claim 1, wherein the one or more layers of the bottom are padding.

9. A collapsible changing booth comprising:
a non-transparent tubular covering having a top end and a bottom end and a diameter configured to accept a user therein;
a spring having substantially the same diameter as the tubular covering, the spring attached to the tubular covering at one or more points such that the tubular covering and the spring expand and contract together;
one or more elongated members extending from the bottom end;
one or more locking mechanisms configured to secure to a plurality of points along the length of the one or more elongated members, wherein the one or more locking mechanisms engage the spring to prevent the spring from expanding beyond a particular point.

10. The collapsible changing booth of claim 9 further comprising one or more channels extending along the length of the tubular covering, wherein the one or more elongated members extend through the one or more channels.

11. The collapsible changing booth of claim 9 further comprising a bottom comprising one or more layers of material configured to enclose the bottom end of the tubular covering.

12. The collapsible changing booth of claim 9 further comprising a lid configured to enclose the top end of the tubular covering.

13. The collapsible changing booth of claim 9, wherein the one or more elongated members are cords.

14. The collapsible changing booth of claim 9, wherein the one or more locking mechanisms are cord cinchers.

15. The collapsible changing booth of claim 9 further comprising one or more straps at the bottom end of the tubular covering, the one or more straps configured to hold the spring in a collapsed state.

16. A method of providing a collapsible changing booth comprising:
providing a non-transparent tubular covering supported by a spring, the spring having a diameter configured to accept a user therein and configured to bias toward an expanded state;
attaching one or more elongated members at a bottom end of the tubular covering;
providing one or more releasable locking mechanisms configured to engage the spring to prevent the spring from expanding beyond a particular height; and
securing the one or more locking mechanisms to the one or more elongated members at the particular height to set the height of the collapsible changing booth.

17. The method of claim 16 further comprising releasing the one or more locking mechanisms from the one or elongated members and re-securing the one or more locking members at another particular height to set a new height for the collapsible changing booth.

18. The method of claim 16 further comprising attaching a lid to a top end of the tubular covering.

19. The method of claim 16 further comprising accepting a user within the tubular covering and the diameter of the spring.

20. The method of claim 16 further comprising attaching the tubular covering to the spring at one or more points so that the tubular covering and the spring expand and contract together.
